(19) United States
(12) Patent Application Publication
(10) Pub. No.: US 2023/0268518 A1
(43) Pub. Date: Aug. 24, 2023

(54) HIGH SURFACE AREA ELECTRODE FOR SOLID-STATE BATTERY

(71) Applicant: NISSAN NORTH AMERICA, INC., Franklin, TN (US)

(72) Inventors: Mohammed Hussain ABDUL JABBAR, Novi, MI (US); Sandeep PATIL, Farmington Hills, MI (US)

(21) Appl. No.: 17/680,091

(22) Filed: Feb. 24, 2022

(51) Int. Cl. H01M 4/70; H01M 10/0525

(52) U.S. Cl. CPC H01M 4/70; H01M 10/0525; H01M 2004/028

(57) ABSTRACT

An electrode is provided that includes a current collector and an electrode material comprising an electrode active material. The current collector includes at least one groove formed in the current collector. The electrode material is provided within the at least one groove, and the at least one groove has a prescribed depth from a surface of the current collector. A battery is also provided that includes a cathode, an anode, and an electrolyte disposed between the cathode and the anode. At least one of the anode and the cathode includes a current collector and an electrode active material in which the electrode material is provided within at least one groove of the current collector, and the at least one groove has a prescribed depth from a surface of the current collector.

### BACKGROUND

### Field of the Invention

The present invention generally relates to a high surface area electrode for a solid-state battery, and a solid-state battery including the high surface area electrode. The electrode includes a current collector and an electrode material comprising an electrode active material. The current collector includes at least one groove formed in the current collector. The electrode material is provided within the at least one groove, and the at least one groove has a prescribed depth from a surface of the current collector.

### Background Information

Lithium-based batteries that include lithium metal anodes or lithium-based cathode material are desirable because they have a high energy density and, thus, can generate a large amount of power with a relatively thin electrode structure, thus permitting a reduction in the size of the battery as compared with other conventional batteries including anodes made of carbon or silicon. Lithium-based batteries use lithium metal anodes and cathodes formed of complex oxides such as lithium nickel manganese cobalt oxide (LiNiMnCoO₂, also commonly referred to as “NMC”). However, there are several drawbacks with lithium metal anodes. For example, the performance of lithium metal anodes is limited by current density as such anodes are prone to excessive dendritic growth and accumulation of dead lithium resulting in severe volume expansion of lithium metal anodes in the battery.

In order to improve the safety and energy storage capacity of lithium-based batteries using solid electrolytes, solid-state batteries have been developed that use a solid or polymer electrolyte to conduct lithium ions between the anode and cathode. Solid-state batteries allow for a much smaller battery size due to their improved energy density. Solid state lithium-based batteries also have an improved safety performance, an enhanced life cycle and higher charge/discharge rates as compared with conventional lithium-ion batteries using a liquid electrolyte, which can lead to undesirable dendrite formation and short-circuiting. However, conventional solid-state batteries have an increased ohmic resistance due to the poor contact between the current collectors and the electrode materials.

Therefore, further improvement is needed to sufficiently reduce the ohmic resistance and overall performance of the solid-state battery. In particular, it is desirable to increase the contact between the electrode current collectors and the electrode materials and thereby decrease the ohmic resistance of the battery.

### SUMMARY

It has been discovered that the contact between the anode or cathode current collector and the respective electrode material can be increased by intentionally increasing the surface area of the current collector by forming at least one groove having a prescribed depth in the current collector and providing the electrode material within the at least one groove.

In particular, it has been discovered that the surface area of a metal current collector can be increased by etching grooves in the surface of the metal current collector on which the electrode material is provided using a laser or by stamping. The grooves are formed to a prescribed depth and can form a pattern in the current collector. The electrode material is then deposited within the grooves and optionally on the top surface of the current collector. By incorporating this electrode structure in one or both of the anode and cathode of a solid-state battery, the ohmic resistance of the battery can be reduced to improve the battery performance. Therefore, it is desirable to provide a solid state battery that includes such an electrode as the anode, the cathode or both the anode and the cathode.

In view of the state of the known technology, one aspect of the present disclosure is to provide an electrode. The electrode includes a current collector and an electrode material comprising an electrode active material. The current collector includes at least one groove formed therein. The electrode material is provided within the at least one groove, and the at least one groove has a prescribed depth from a surface of the current collector.

Another aspect of the present disclosure is to provide a battery including a high surface area electrode. The battery includes a cathode, an anode and an electrolyte disposed between the cathode and the anode. At least one of the anode and the cathode includes a current collector and an electrode active material. The current collector includes at least one groove formed therein, and the electrode material is provided within the at least one groove. The at least one groove has a prescribed depth from a surface of the current collector.

A further aspect of the present disclosure is to provide a battery including a first metal support having at least one groove formed therein, an anode material formed on the first metal support, an electrolyte formed on the anode material, a cathode material formed on the electrolyte, and a second metal support provided on the cathode material. The at least one groove has a prescribed depth from a first surface of the first metal support. The anode material is provided on the first surface of the first metal support and within the at least one groove. The electrolyte is provided on the first surface of the first metal support and within the at least one groove, and the cathode material is provided on the first surface of the first metal support and within the at least one groove. The second metal support has at least one projection configured to mate with the at least one groove of the first metal support such that the at least one projection of the second metal support is provided within the at least one groove of the first metal support.

By providing the grooves in at least one electrode of the battery, the contact between the electrode material and the current collector of the electrode can be improved. Thus, the ohmic resistance of the battery can be decreased and the overall battery performance improved. Furthermore, by providing two metal supports, one with grooves and another with projections that mate with the grooves of the other metal support, the ohmic resistance of the battery can be improved at both electrodes while also further reducing the size of the battery as compared with a case where the high surface area electrodes are merely stacked on each other with a flat electrode layer therebetween.

### BRIEF DESCRIPTION OF THE DRAWINGS

Referring now to the attached drawings which form a part of this original disclosure:

FIG. 1a is a perspective view of a solid state battery according to one embodiment;

FIG. 1b is an exploded perspective view of the solid state battery of FIG. 1a;

FIG. 1c is a partial bottom perspective view of the cathode of FIG. 1a;

FIG. 1d is a partial top perspective view of the anode of FIG. 1a; and

FIG. 2a is a perspective view of a solid state battery according to an embodiment;

FIG. 2b is an exploded perspective view of the solid state battery of FIG. 2a;

FIG. 2c is a partial bottom perspective view of the cathode of FIG. 2a;

FIG. 2d is a partial top perspective view of the anode of FIG. 2a;

FIG. 3a is a perspective view of a solid state battery according to one embodiment;

FIG. 3b is an exploded perspective view of the solid state battery of FIG. 3a;

FIG. 3c is a bottom perspective view of the cathode of FIG. 3a;

FIG. 3d is a top perspective view of the anode of FIG. 3a;

FIG. 4a is a top perspective view of an electrode according to an embodiment;

FIG. 4b is a bottom perspective view of the electrode of FIG. 4a;

FIG. 5a is a perspective view of a solid state battery according to one embodiment;

FIG. 5b is a bottom perspective view of the first metal support of FIG. 5a;

FIG. 5c is a top perspective view of the cathode of FIG. 5a;

FIG. 5d is a top perspective view of the electrolyte of FIG. 5a;

FIG. 5e is a top perspective view of the anode of FIG. 5a;

FIG. 5f is a top perspective view of the second metal support of FIG. 5a;

FIG. 5g is a partial perspective view of the solid state battery of FIG. 5a; and

FIG. 6 is an illustrated flow chart showing a method of producing a solid state battery including a high surface area electrode according to an embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

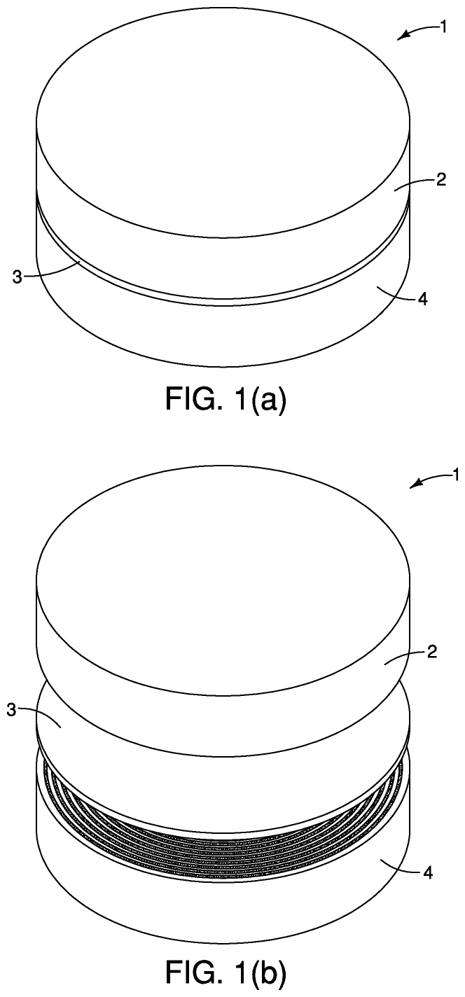

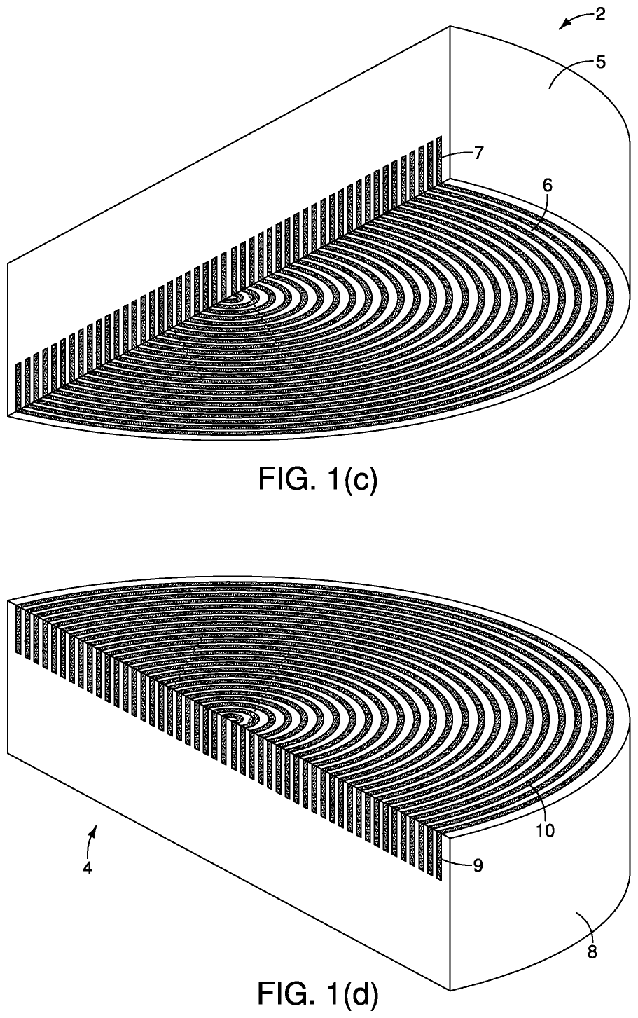

Referring initially to FIGS. 1a and 1b, a solid-state battery 1 is illustrated that includes a cathode 2, an electrolyte 3, and an anode 4 in accordance with a first embodiment. The solid-state battery 1 can be incorporated in a vehicle, a mobile device, a laptop computer or other suitable personal electronic device. The solid-state battery 1 is preferably an all-solid-state battery.

As shown in FIG. 1c, the cathode 2 includes a cathode current collector 5, a plurality of grooves 6 formed in the cathode current collector 5, and a cathode material 7 that is provided in the grooves 6 so as to fill the grooves 6. The cathode current collector 5 is formed of any suitable metal material, such as aluminum or copper, preferably aluminum. The cathode current collector 5 has a thickness ranging from 60 μm to 100 μm, preferably 60 μm.

The grooves 6 are formed in a pattern of concentric circles as shown in FIG. 1c. However, it should be understood that the grooves 6 may be formed in any suitable pattern, as long as the surface area of the cathode current collector 5 is increased as compared with the surface area of the cathode current collector 5 with no grooves. Preferably, the surface area of the cathode current collector 5 is increased at least 1.5 times by providing the grooves 6. The grooves 6 are preferably formed in a circular or pie-shaped pattern, but a square pattern is also possible. Conventional current collectors for solid state batteries have a surface area of about 80 mm². However, when the grooves are provided, the surface area of the current collector can be increased to 140 mm² or more.

Each of the grooves 6 has a same prescribed depth from a bottom surface of the cathode current collector 5 that faces the electrolyte 4. For example, each of the grooves 6 has a prescribed depth of at least ⅓ of the total thickness of the cathode current collector 5. However, it should be understood that the grooves 6 may have different depths from the bottom surface of the cathode current collector 5, as long as each of the grooves 6 has a prescribed depth of at least ⅓ of the total thickness of the cathode current collector 5. Preferably, each of the grooves 6 has a prescribed depth of 20 μm to 40 μm.

The grooves 6 may be formed in any suitable manner, for example using a laser to perform laser etching. The grooves 6 may also be formed by stamping.

The cathode material 7 includes a cathode active material. The cathode material 7 may also include a binder and an additive. The cathode active material is any suitable cathode active material that is compatible with a solid electrolyte. For example, the cathode active material may be a lithium transition metal oxide such as NMC or lithium cobalt oxide, lithium phosphate, lithium iron phosphate or a mixture thereof. The cathode active material is formed of particles having a diameter of approximately 15 nm to 5 μm.

The cathode material 7 may also include an additive (such as sacrificial cathode materials that acts as an additional source of lithium ions) and/or a binder. The cathode material 7 includes at least 80 percent by weight of the cathode active material, preferably at least 90 percent by weight of the cathode active material. The cathode material 7 also includes up to five percent by weight of the additive plus the binder. For example, the cathode material 7 may include approximately two percent by weight of the additive and approximately three percent by weight of the binder. The weight percentage values described above are relative to a total weight of the cathode material 7.

The binder may be any suitable electrode binder material. For example, the binder may include polyvinylidene fluoride, styrene-butadiene rubber, a cellulose material or any combination thereof. The additive may be any suitable sacrificial electrode additive, such as a material that acts as an additional source of lithium ions.

The cathode material 7 preferably includes a mixture of NMC, an electron conducting material such as carbon and a lithium-ion conductive material such as a sulfide electrolyte.

As shown in FIG. 1c, the cathode material 7 is provided only within the grooves 6 and fills the entirety of the grooves 6. However, it should be understood that the cathode material 7 can also be provided on the bottom surface of the cathode current collector 5 such that, in addition to the cathode material 7 provided within the grooves 6, a layer of cathode material 7 is provided between the cathode current collector 5 and the electrolyte 4.

The electrolyte 3 is any suitable electrolyte for a solid-state battery, such as a solid electrolyte. The solid electrolyte can be any suitable lithium-ion conductive solid electrolyte. For example, the solid electrolyte can be a sulfide-based solid electrolyte, such as Li₆PS₅Cl, an oxide solid electrolyte, or a hybrid solid electrolyte that includes a sulfide-based solid electrolyte and a polyethylene oxide (“PEO”) based polymer. The electrolyte 3 has a thickness of approximately 10 μm to 20 μm.

As shown in FIG. 1d, the anode 4 includes an anode current collector 8, a plurality of grooves 9 formed in the anode current collector 8, and a cathode material 10 that is provided in the grooves 9 so as to fill the grooves 9. The anode current collector 8 is formed of any suitable metal material, such as aluminum or copper, preferably copper. The anode current collector 8 has a thickness ranging from 60 μm to 100 μm, preferably 60 μm.

The grooves 9 are formed in a pattern of concentric circles as shown in FIG. 1d. However, it should be understood that the grooves 9 may be formed in any suitable pattern, as long as the surface area of the anode current collector 8 is increased as compared with the surface area of the anode current collector 8 with no grooves. Preferably, the surface area of the anode current collector 8 is increased at least 1.5 times by providing the grooves 9. The grooves 9 are preferably formed in a circular or pie-shaped pattern, but a square pattern is also possible. Conventional current collectors for solid state batteries have a surface area of about 80 mm². However, when the grooves are provided, the surface area of the current collector can be increased to 140 mm² or more.

Each of the grooves 9 has a same prescribed depth from a top surface of the anode current collector 8 that faces the electrolyte 4. For example, each of the grooves 9 has a prescribed depth of at least ⅓ of the total thickness of the anode current collector 8. However, it should be understood that the grooves 9 may have different depths from the bottom surface of the anode current collector 8, as long as each of the grooves 9 has a prescribed depth of at least ⅓ of the total thickness of the anode current collector 8. Preferably, each of the grooves 9 has a prescribed depth of 20 μm to 40 μm.

The grooves 9 may be formed in any suitable manner, for example using a laser to perform laser etching. The grooves 9 may also be formed by stamping.

The anode material 10 includes an anode active material. The anode material 10 may also include a binder and an additive. The anode active material is any suitable anode active material that is compatible with a solid electrolyte. For example, the anode active material is formed of metal, preferably entirely of metal. The anode active material is preferably formed of lithium, sodium, magnesium, or a mixture thereof. For example, the anode active material may be formed of lithium or a lithium alloy.

The anode material 10 may also include an additive and/or a binder. The anode material 10 includes approximately 90-95 percent by weight of the anode active material and five to ten percent by weight of the additive plus the binder. For example, the anode material 10 may include approximately 95.0 percent by weight of the anode active material, 2.5 percent by weight of the additive and 2.5 percent by weight of the binder.

The binder may be any suitable electrode binder material. For example, the binder may include polyvinylidene fluoride, styrene-butadiene rubber, a cellulose material or any combination thereof. The additive may be any suitable sacrificial electrode additive, such as a material that acts as an additional source of lithium ions.

The anode material 10 may be formed by mixing the anode active material, the additive and the binder with a suitable solvent, such as N-methyl pyrrolidone (NMP). The weight ratio of the solvent to the sum of the anode active material, the additive and the binder may be approximately 2:1.

As shown in FIG. 1d, the anode material 10 is provided only within the grooves 9 and fills the entirety of the grooves 9. However, it should be understood that the anode material 10 can also be provided on the top surface of the anode current collector 8 such that, in addition to the anode material 10 provided within the grooves 9, a layer of anode material 10 is provided between the anode current collector 8 and the electrolyte 4.

When a sulfide-based solid electrolyte is used as the electrolyte 3 and the anode material 10 includes lithium metal, a protective layer (not shown) may be also provided between the electrolyte 3 and the anode 4.

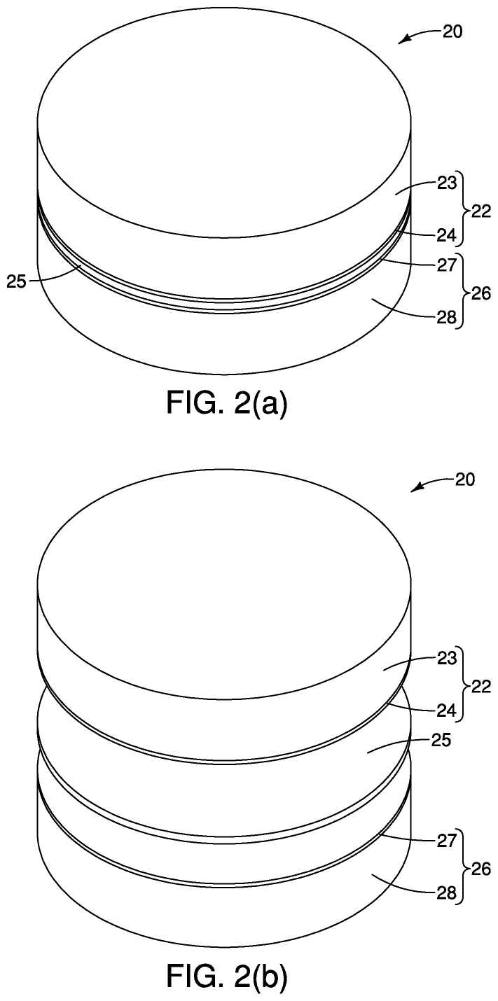

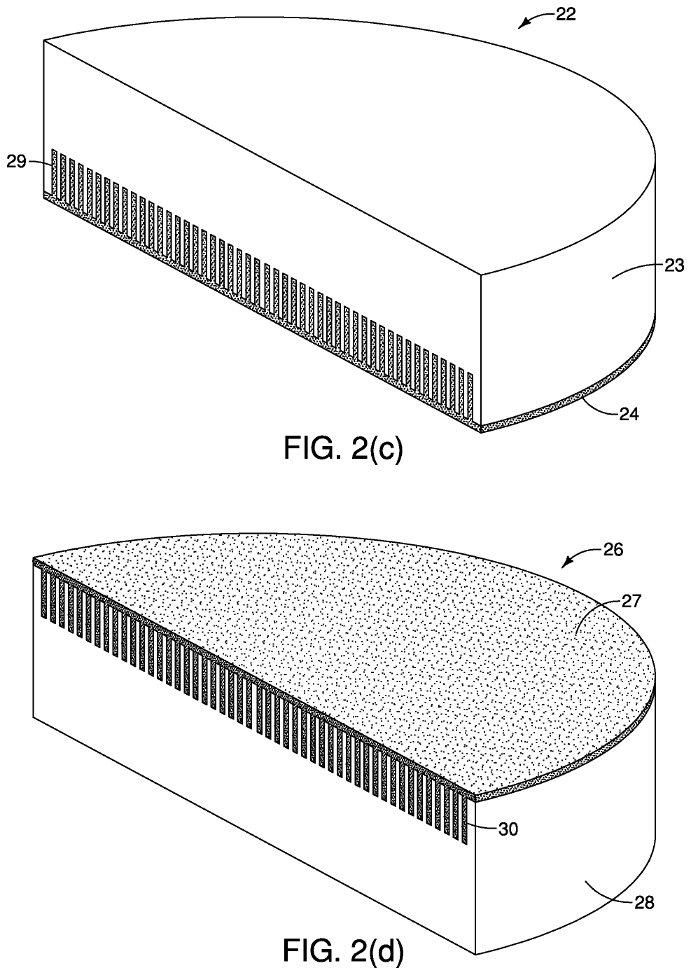

FIGS. 2a and 2b show a solid-state battery 20 that includes a cathode 22 formed of a cathode current collector 23 and a cathode material 24, an electrolyte 25, and an anode 26 formed of an anode current collector 27 and an anode material 28 in accordance with a second embodiment. Like the solid-state battery 1 of the first embodiment, the solid-state battery 20 is preferably an all-solid-state battery and can be incorporated in a vehicle, a mobile device, a laptop computer or other suitable personal electronic devices.

As shown in FIG. 2c, the cathode 22 includes a cathode current collector 23, a plurality of grooves 29 formed in the cathode current collector 23, and a cathode material 24 that is provided within the grooves 29 and on the bottom surface of the cathode current collector 23 so as to form a layer between the cathode 22 and the electrolyte 25. The cathode current collector 23 is formed of any suitable metal material, such as aluminum or copper, preferably aluminum. The cathode current collector 23 has a thickness ranging from 60 μm to 100 μm, preferably 60 μm.

Although not fully shown in FIG. 2c, the grooves 29 are formed in a pattern of concentric circles. However, it should be understood that the grooves 29 may be formed in any suitable pattern, as long as the surface area of the cathode current collector 23 is increased as compared with the surface area of the cathode current collector 23 with no grooves. Preferably, the surface area of the cathode current collector 23 is increased at least 1.5 times by providing the grooves 29. The grooves 29 are preferably formed in a circular or pie-shaped pattern, but a square pattern is also possible. Conventional current collectors for solid state batteries have a surface area of about 80 mm². However, when the grooves are provided, the surface area of the current collector can be increased to 140 mm² or more.

Each of the grooves 29 has a same prescribed depth from a bottom surface of the cathode current collector 23 that faces the electrolyte 25. For example, each of the grooves 29 has a prescribed depth of at least ⅓ of the total thickness of the cathode current collector 23. However, it should be understood that the grooves 29 may have different depths from the bottom surface of the cathode current collector 23, as long as each of the grooves 29 has a prescribed depth of at least ⅓ of the total thickness of the cathode current collector 23. Preferably, each of the grooves 29 has a prescribed depth of 20 μm to 40 μm.

The grooves 29 may be formed in any suitable manner, for example using a laser to perform laser etching. The grooves 29 may also be formed by stamping.

The cathode material 24 includes a cathode active material. The cathode material 24 may also include a binder and an additive. The cathode active material is any suitable cathode active material that is compatible with a solid electrolyte. For example, the cathode active material may be a lithium transition metal oxide such as NMC or lithium cobalt oxide, lithium phosphate, lithium iron phosphate or a mixture thereof. The cathode active material is formed of particles having a diameter of approximately 15 nm to 5 μm.

The cathode material 24 may also include an additive (such as sacrificial cathode materials that acts as an additional source of lithium ions) and/or a binder. The cathode material 24 includes at least 80 percent by weight of the cathode active material, preferably at least 90 percent by weight of the cathode active material. The cathode material 24 also includes up to five percent by weight of the additive plus the binder. For example, the cathode material 24 may include approximately two percent by weight of the additive and approximately three percent by weight of the binder. The weight percentage values described above are relative to a total weight of the cathode material 24.

The binder may be any suitable electrode binder material. For example, the binder may include polyvinylidene fluoride, styrene-butadiene rubber, a cellulose material or any combination thereof. The additive may be any suitable sacrificial electrode additive, such as a material that acts as an additional source of lithium ions.

The cathode material 24 preferably includes a mixture of NMC, an electron conducting material such as carbon and a lithium-ion conductive material such as a sulfide electrolyte.

As shown in FIG. 2c, the cathode material 24 is provided both within the grooves 29 so as to fill the entirety of the grooves 29 and also on the bottom surface of the cathode current collector 23 so as to form a layer between the cathode current collector 23 and the electrolyte 25. However, it should be understood that the cathode material 24 may be provided only within the grooves 29.

The electrolyte 25 is any suitable electrolyte for a solid-state battery, such as a solid electrolyte. The solid electrolyte can be any suitable lithium-ion conductive solid electrolyte. For example, the solid electrolyte can be a sulfide-based solid electrolyte, such as Li₆PS₅Cl, an oxide solid electrolyte, or a hybrid solid electrolyte that includes a sulfide-based solid electrolyte and a PEO based polymer. The electrolyte 25 has a thickness of approximately 10 μm to 20 μm.

As shown in FIG. 2d, the anode 26 includes an anode material 27, an anode current collector 28, a plurality of grooves 30 formed in the anode current collector 28. The anode material 27 includes an anode active material. The anode material 27 may also include a binder and an additive. The anode active material is any suitable anode active material that is compatible with a solid electrolyte. For example, the anode active material is formed of metal, preferably entirely of metal. The anode active material is preferably formed of lithium, sodium, magnesium, or a mixture thereof. For example, the anode active material may be formed of lithium or a lithium alloy.

The anode material 27 may also include an additive and/or a binder. The anode material 27 includes approximately 90-95 percent by weight of the anode active material and five to ten percent by weight of the additive plus the binder. For example, the anode material 27 may include approximately 95.0 percent by weight of the anode active material, 2.5 percent by weight of the additive and 2.5 percent by weight of the binder.

The anode material 27 may be formed by mixing the anode active material, the additive and the binder with a suitable solvent, such as N-methyl pyrrolidone (NMP). The weight ratio of the solvent to the sum of the anode active material, the additive and the binder may be approximately 2:1.

As shown in FIG. 2d, the anode material 27 is provided both within the grooves 30 so as to fill the entirety of the grooves 30 and also on the top surface of the anode current collector 28 so as to form a layer between the anode current collector 28 and the electrolyte 25. However, it should be understood that the anode material 27 may be provided only within the grooves 30.

When a sulfide-based solid electrolyte is used as the electrolyte 25 and the anode material 27 includes lithium metal, a protective layer (not shown) may be also provided between the electrolyte 25 and the anode material 27.

The anode current collector 28 is formed of any suitable metal material, such as aluminum or copper, preferably copper. The anode current collector 28 has a thickness ranging from 60 μm to 100 μm, preferably 60 μm.

Although not fully shown in FIG. 2d, the grooves 30 are formed in a pattern of concentric circles. However, it should be understood that the grooves 30 may be formed in any suitable pattern, as long as the surface area of the anode current collector 28 is increased as compared with the surface area of the anode current collector 28 with no grooves. Preferably, the surface area of the anode current collector 28 is increased at least 1.5 times to approximately 140 mm² or more by providing the grooves 30. The grooves 30 are preferably formed in a circular or pie-shaped pattern, but a square pattern is also possible.

Each of the grooves 30 has a same prescribed depth from a top surface of the cathode current collector 28 that faces the electrolyte 25. For example, each of the grooves 30 has a prescribed depth of at least ⅓ of the total thickness of the anode current collector 28. However, it should be understood that the grooves 30 may have different depths from the bottom surface of the anode current collector 28, as long as each of the grooves 30 has a prescribed depth of at least ⅓ of the total thickness of the anode current collector 28. Preferably, each of the grooves 30 has a prescribed depth of 20 μm to 40 μm.

The grooves 30 may be formed in any suitable manner, for example using a laser to perform laser etching. The grooves 30 may also be formed by stamping.

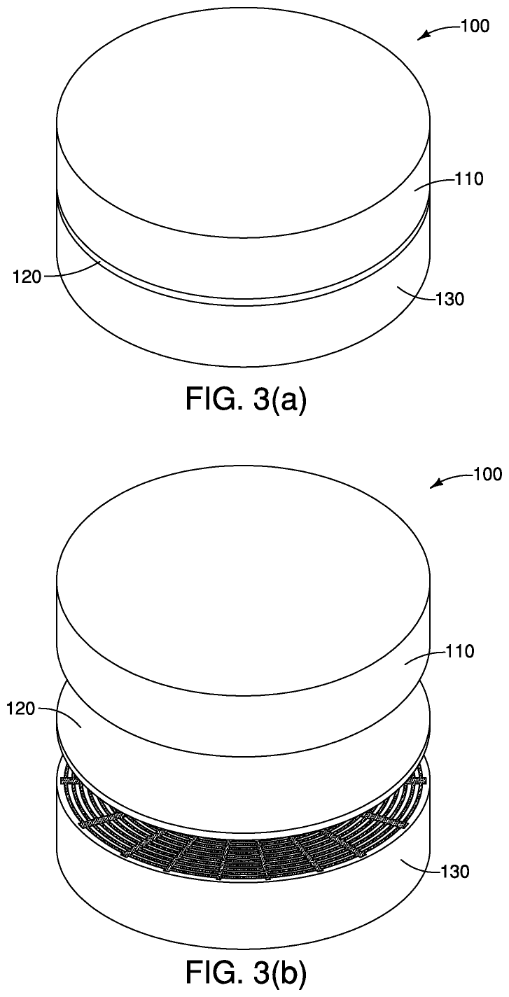

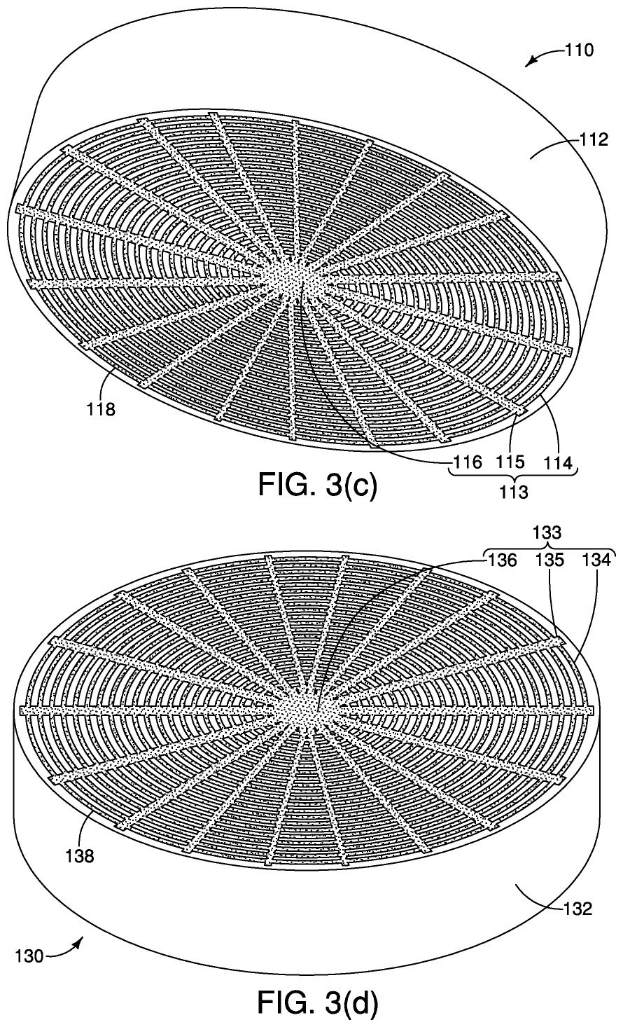

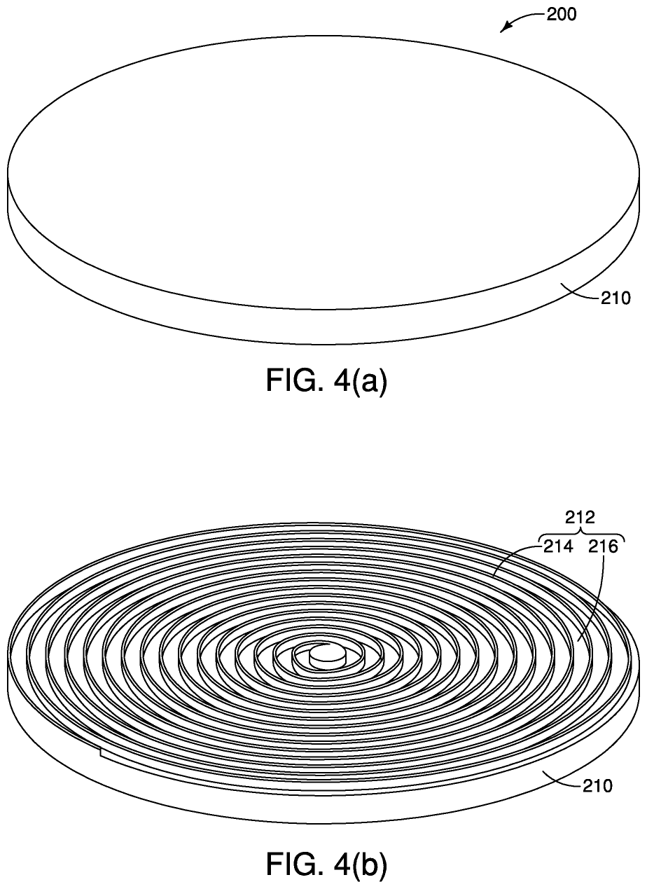

FIGS. 3a and 3b show a solid-state battery 100 that includes a cathode 110, an electrolyte 120, and an anode 130 in accordance with a third embodiment. Like the solid-state battery of the first and second embodiments, the solid-state battery 100 is preferably an all-solid-state battery and can be incorporated in a vehicle, a mobile device, a laptop computer or other suitable personal electronic devices.

As shown in FIG. 3c, the cathode 110 includes a cathode current collector 112 and a plurality of grooves 113 formed in the cathode current collector 112. The cathode current collector 112 is formed of any suitable metal material, such as aluminum or copper, preferably aluminum. The cathode current collector 112 has a thickness ranging from 60 μm to 100 μm, preferably 60 μm.

As shown in FIG. 3c, the plurality of grooves 113 includes a plurality of circular grooves 114 that form a pattern of concentric circles, a plurality of line-shaped grooves 115 that form a pie-shaped pattern, and a central groove 116 formed in a circular pattern. However, it should be understood that the grooves 113 may be formed in any suitable pattern, as long as the surface area of the cathode current collector 112 is increased as compared with the surface area of the cathode current collector 112 with no grooves. Preferably, the surface area of the cathode current collector 112 is increased at least 1.5 times, to approximately 140 mm² or more, by providing the grooves 113. The grooves 113 are preferably formed in a circular or pie-shaped pattern, but a square pattern is also possible.

Each of the grooves 113 has a same prescribed depth from a bottom surface of the cathode current collector 112 that faces the electrolyte 120. For example, each of the grooves 113 has a prescribed depth of at least ⅓ of the total thickness of the cathode current collector 112. However, it should be understood that the grooves 113 may have different depths from the bottom surface of the cathode current collector 112, as long as each of the grooves 113 has a prescribed depth of at least ⅓ of the total thickness of the cathode current collector 112. Preferably, each of the grooves 113 has a prescribed depth of 20 μm to 40 μm.

The grooves 113 may be formed in any suitable manner, for example using a laser to perform laser etching. The grooves 113 may also be formed by stamping.

The cathode 110 also includes a cathode material 118 provided within the grooves 114, 115 and 116. The cathode material 118 includes a cathode active material. The cathode material 118 may also include a binder and an additive. The cathode active material is any suitable cathode active material that is compatible with a solid electrolyte. For example, the cathode active material may be a lithium transition metal oxide such as NMC or lithium cobalt oxide, lithium phosphate, lithium iron phosphate or a mixture thereof. The cathode active material is formed of particles having a diameter of approximately 15 nm to 5 μm.

The cathode material 118 may also include an additive (such as sacrificial cathode materials that acts as an additional source of lithium ions) and/or a binder. The cathode material 118 includes at least 80 percent by weight of the cathode active material, preferably at least 90 percent by weight of the cathode active material. The cathode material 118 also includes up to five percent by weight of the additive plus the binder. For example, the cathode material 118 may include approximately two percent by weight of the additive and approximately three percent by weight of the binder. The weight percentage values described above are relative to a total weight of the cathode material 118.

The binder may be any suitable electrode binder material. For example, the binder may include polyvinylidene fluoride, styrene-butadiene rubber, a cellulose material or any combination thereof. The additive may be any suitable sacrificial electrode additive, such as a material that acts as an additional source of lithium ions.

The cathode material 118 preferably includes a mixture of NMC, an electron conducting material such as carbon and a lithium-ion conductive material such as a sulfide electrolyte.

As shown in FIG. 3c, the cathode material 118 is provided only within the grooves 113 and fills the entirety of the grooves 113. However, it should be understood that the cathode material 113 can also be provided on the bottom surface of the cathode current collector 112 such that, in addition to the cathode material 118 provided within the grooves 113, a layer of cathode material 118 is provided between the cathode current collector 112 and the electrolyte 120.

The electrolyte 120 is any suitable electrolyte for a solid-state battery, such as a solid electrolyte. The solid electrolyte can be any suitable lithium-ion conductive solid electrolyte. For example, the solid electrolyte can be a sulfide-based solid electrolyte, such as Li₆PS₅Cl, an oxide solid electrolyte, or a hybrid solid electrolyte that includes a sulfide-based solid electrolyte and a polyethylene oxide (“PEO”) based polymer. The electrolyte 112 has a thickness of approximately 10 μm to 20 μm.

As shown in FIG. 3d, the anode 130 includes an anode current collector 132 and a plurality of grooves 133 formed in the anode current collector 132. The anode current collector 132 is formed of any suitable metal material, such as aluminum or copper, preferably copper. The anode current collector 132 has a thickness ranging from 60 μm to 100 μm, preferably 60 μm.

As shown in FIG. 3d, the plurality of grooves 133 includes a plurality of circular grooves 134 that form a pattern of concentric circles, a plurality of line-shaped grooves 135 that form a pie-shaped pattern, and a central groove 136 formed in a circular pattern. However, it should be understood that the grooves 133 may be formed in any suitable pattern, as long as the surface area of the anode current collector 132 is increased as compared with the surface area of the anode current collector 132 with no grooves. Preferably, the surface area of the anode current collector 132 is increased at least 1.5 times to 140 mm² or more by providing the grooves 133. The grooves 133 are preferably formed in a circular or pie-shaped pattern, but a square pattern is also possible.

Each of the grooves 133 has a same prescribed depth from a top surface of the anode current collector 132 that faces the electrolyte 120. For example, each of the grooves 133 has a prescribed depth of at least ⅓ of the total thickness of the anode current collector 132. However, it should be understood that the grooves 133 may have different depths from the bottom surface of the anode current collector 132, as long as each of the grooves 133 has a prescribed depth of at least ⅓ of the total thickness of the anode current collector 132. Preferably, each of the grooves 133 has a prescribed depth of 20 μm to 40 μm.

The grooves 133 may be formed in any suitable manner, for example using a laser to perform laser etching. The grooves 133 may also be formed by stamping.

The anode 130 also includes an anode material 138 includes an anode active material. The anode material 138 may also include a binder and an additive. The anode active material is any suitable anode active material that is compatible with a solid electrolyte. For example, the anode active material is formed of metal, preferably entirely of metal. The anode active material is preferably formed of lithium, sodium, magnesium, or a mixture thereof. For example, the anode active material may be formed of lithium or a lithium alloy.

The anode material 138 may also include an additive and/or a binder. The anode material 138 includes approximately 90-95 percent by weight of the anode active material and five to ten percent by weight of the additive plus the binder. For example, the anode material 138 may include approximately 95.0 percent by weight of the anode active material, 2.5 percent by weight of the additive and 2.5 percent by weight of the binder.

The binder may be any suitable electrode binder material. For example, the binder may include polyvinylidene fluoride, styrene-butadiene rubber, a cellulose material or any combination thereof. The additive may be any suitable sacrificial electrode additive, such as a material that acts as an additional source of lithium ions.

The anode material 138 may be formed by mixing the anode active material, the additive and the binder with a suitable solvent, such as N-methyl pyrrolidone (NMP). The weight ratio of the solvent to the sum of the anode active material, the additive and the binder may be approximately 2:1.

As shown in FIG. 3d, the anode material 138 is provided only within the grooves 133 and fills the entirety of the grooves 133. However, it should be understood that the anode material 138 can also be provided on the top surface of the anode current collector 132 such that, in addition to the anode material 138 provided within the grooves 133, a layer of anode material 138 is provided between the anode current collector 132 and the electrolyte 120.

When a sulfide-based solid electrolyte is used as the electrolyte 120 and the anode material 138 includes lithium metal, a protective layer (not shown) may be also provided between the electrolyte 120 and the anode 130.

FIGS. 4a and 4b show an electrode 200 for a solid-state battery in accordance with a fourth embodiment. The electrode 200 includes a current collector 210 and a plurality of grooves 212 formed by a plurality of raised portions 214 and a plurality of spaces 216 between the raised portions 214. The electrode 200 can be used as a cathode or an anode in a solid-state battery, and the solid-state battery can be incorporated in a vehicle, a mobile device, a laptop computer or other suitable personal electronic device.

The current collector 210 is formed of any suitable metal material, such as aluminum or copper. The current collector 210 has a thickness ranging from 60 μm to 100 μm, preferably 60 μm.

As shown in FIG. 4b, the grooves 212 are formed in a pattern of concentric circles. However, it should be understood that the grooves 212 may be formed in any suitable pattern, as long as the surface area of the cathode current collector 210 is increased as compared with the surface area of the cathode current collector 210 with no grooves. Preferably, the surface area of the cathode current collector 210 is increased at least 1.5 times by providing the grooves 6. The grooves 212 are preferably formed in a circular or pie-shaped pattern, but a square pattern is also possible. Conventional current collectors for solid state batteries have a surface area of about 80 mm². However, when the grooves are provided, the surface area of the current collector can be increased to 140 mm² or more.

Each of the spaces 216 has a same prescribed depth from a surface of the raised portions 214, which is also the bottom surface of the current collector 210 shown in FIG. 4a. For example, each of the spaces 216 has a prescribed depth of at least ⅓ of the total thickness of the cathode current collector 210. However, it should be understood that the spaces 216 may have different depths from the bottom surface of the current collector 210, as long as each of the spaces 216 has a prescribed depth of at least ⅓ of the total thickness of the current collector 210. Preferably, each of the spaces 216 has a prescribed depth of 20 μm to 40 μm.

The raised portions 214 and the spaces 216 that form the grooves 212 may be formed in any suitable manner, for example using a laser to perform laser etching. The raised portions 214 and the spaces 216 may also be formed by stamping.

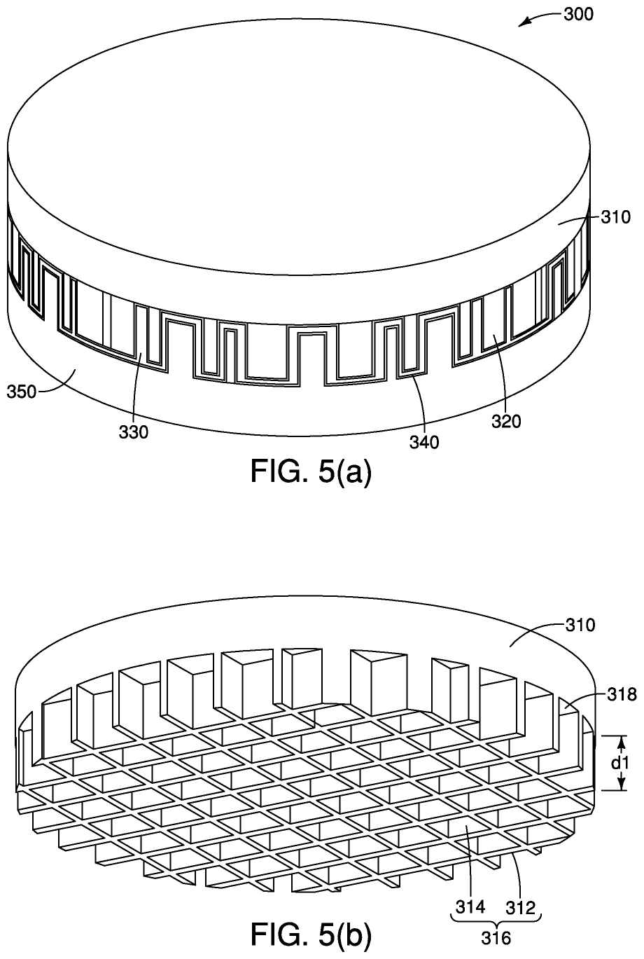

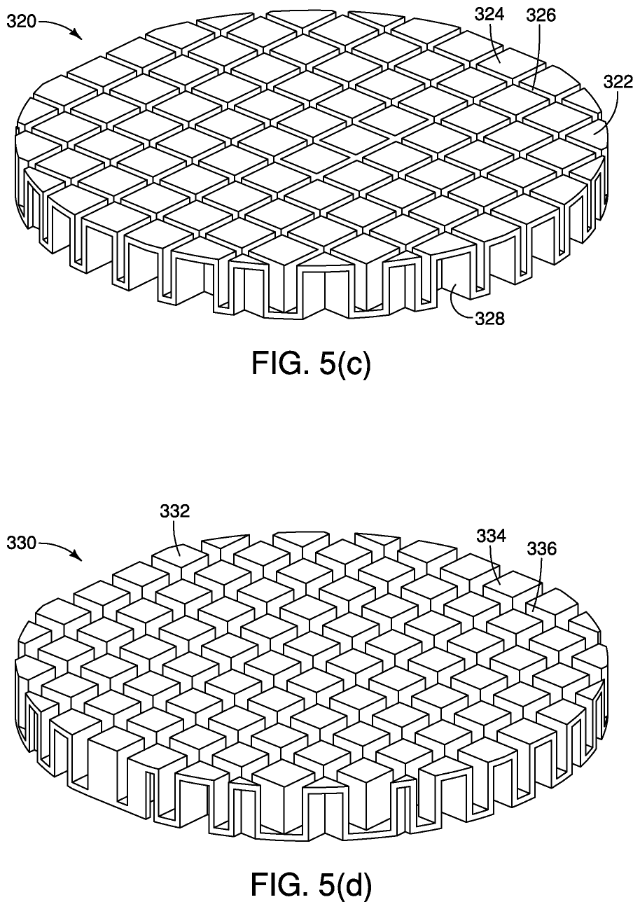

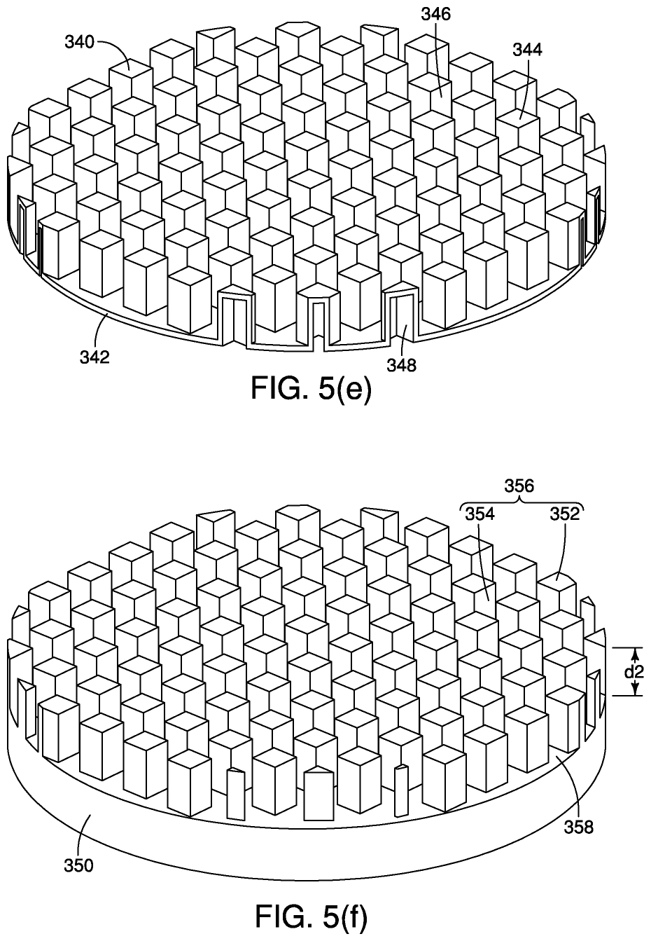

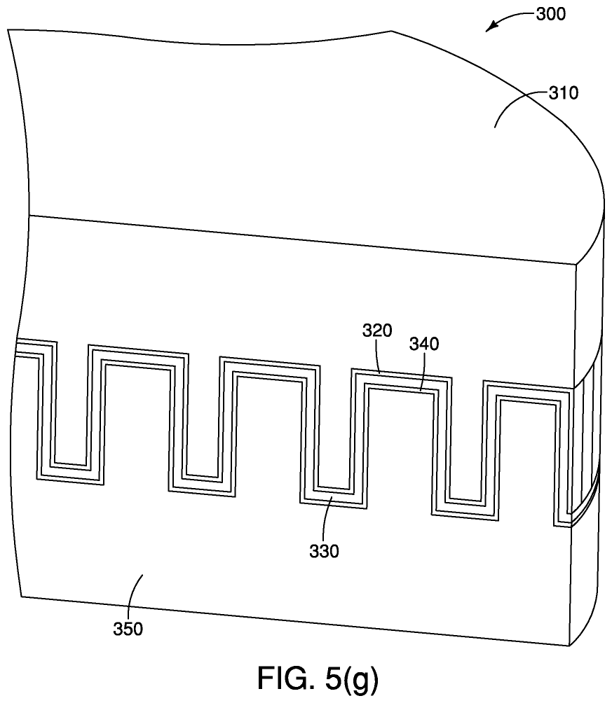

FIG. 5a shows a solid-state battery 300 that includes a first metal support 310, a cathode 320, an electrolyte 330, an anode 340, and a second metal support 350 in accordance with a fifth embodiment. Like the solid-state battery of the first, second and third embodiments, the solid-state battery 300 is preferably an all-solid-state battery and can be incorporated in a vehicle, a mobile device, a laptop computer or other suitable personal electronic devices.

As shown in FIG. 5b, the first metal support 310 has a structure including a plurality of raised portions 312 and a plurality of spaces 314 between the raised portions 312. The first metal support 310 is formed of any suitable metal material, such as aluminum or copper, preferably aluminum. The first metal support 310 has a thickness ranging from 60 μm to 100 μm, preferably 60 μm. The first metal support 310 has a circular shape, but it should be understood that the first metal support 310 may have any suitable shape, such as a square or rectangular shape.

Together, the raised portions 312 and the spaces 314 form a plurality of grooves 316 in the first metal support 310. The raised portions 312 are projections that protrude from an inner surface 318 of the first metal support 310. As shown in FIG. 5b, the plurality of grooves 316 is formed in a grid-like pattern. However, it should be understood that the grooves 316 may be formed in any suitable pattern, as long as the surface area of the first metal support 310 is increased as compared with the surface area of the first metal support 310 with no grooves. Preferably, the surface area of the first metal support 310 is increased at least 1.5 times, to approximately 140 mm² or more, by providing the grooves 316. The grooves 316 are preferably formed in a grid-like pattern, but a circular pattern, a pie-shaped pattern or a square pattern is also possible.

Each of the grooves 316 has a same prescribed depth d1 from a bottom surface of the first metal support 310 that faces the electrolyte 320 to the inner surface 318 of the first metal support 310. For example, each of the grooves 316 has a prescribed depth d1 of at least ⅓ of the total thickness of the first metal support 310. However, it should be understood that the grooves 316 may have different depths from the bottom surface of the first metal support 310 to the inner surface 318 of the first metal support 310, as long as each of the grooves 316 has a prescribed depth of at least ⅓ of the total thickness of the first metal support 310. Preferably, each of the grooves 316 has a prescribed depth of 20 μm to 40 μm.

The grooves 316 may be formed in any suitable manner, for example using a laser to perform laser etching. The grooves 316 may also be formed by stamping.

As shown in FIG. 5c, the cathode 320 is formed of a cathode material 322. The cathode material 322 includes a cathode active material. The cathode material 322 may also include a binder and an additive. The cathode active material is any suitable cathode active material that is compatible with a solid electrolyte. For example, the cathode active material may be a lithium transition metal oxide such as NMC or lithium cobalt oxide, lithium phosphate, lithium iron phosphate or a mixture thereof. The cathode active material is formed of particles having a diameter of approximately 15 nm to 5 μm. The cathode material 322 has a thickness of approximately 20 μm to 40 μm.

The cathode material 322 may also include an additive (such as sacrificial cathode materials that acts as an additional source of lithium ions) and/or a binder. The cathode material 322 includes at least 80 percent by weight of the cathode active material, preferably at least 90 percent by weight of the cathode active material. The cathode material 322 also includes up to five percent by weight of the additive plus the binder. For example, the cathode material 322 may include approximately two percent by weight of the additive and approximately three percent by weight of the binder. The weight percentage values described above are relative to a total weight of the cathode material 322.

The binder may be any suitable electrode binder material. For example, the binder may include polyvinylidene fluoride, styrene-butadiene rubber, a cellulose material or any combination thereof. The additive may be any suitable sacrificial electrode additive, such as a material that acts as an additional source of lithium ions.

The cathode material 322 preferably includes a mixture of NMC, an electron conducting material such as carbon and a lithium-ion conductive material such as a sulfide electrolyte.

The cathode material 322 is formed as a layer on the first metal support 310 so as to entirely cover the first metal support 310. For example, the cathode material 322 is formed as a layer including a plurality of square-shaped raised portions 324 and a plurality of spaces 326 between the raised portions 324 such that the raised portions 324 and the spaces 326 form a grid-like pattern. The raised portions 324 are formed so as to mate with the spaces 314 of the first metal support 310. However, it should be understood that the raised portions 324 may have any suitable shape as long as they are configured to mate with the spaces 314 of the first metal support 310. The cathode material 322 also includes a plurality of second spaces 328 under the raised portions 324. The shape of the second spaces 328 is based on the shape of the raised portions 324.

The electrolyte 330 is formed of an electrolyte material 332. The electrolyte material 332 is any suitable electrolyte for a solid-state battery, such as a solid electrolyte. The solid electrolyte can be any suitable lithium-ion conductive solid electrolyte. For example, the solid electrolyte can be a sulfide-based solid electrolyte, such as Li₆PS₅Cl, an oxide solid electrolyte, or a hybrid solid electrolyte that includes a sulfide-based solid electrolyte and a polyethylene oxide (“PEO”) based polymer. The electrolyte material 332 has a thickness of approximately 10 μm to 20 μm.

As shown in FIG. 5d, the electrolyte material 332 is formed as a layer on the cathode material 322 so as to entirely cover the cathode material 322. For example, the electrolyte material 332 is formed as a layer including a plurality of square-shaped raised portions 334 and a plurality of spaces 336 between the raised portions 334 such that the raised portions 334 and the spaces 336 form a grid-like pattern. The raised portions 334 are formed so as to mate with the second spaces 328 of the cathode material 322. However, it should be understood that the raised portions 334 may have any suitable shape as long as they are configured to mate with the spaces 328 of the cathode material 322. The electrolyte material 332 also includes a plurality of second spaces 338 under the raised portions 334. The shape of the second spaces 338 is based on the shape of the raised portions 334.

As shown in FIG. 5e, the anode 340 is formed of an anode material 342. The anode material 342 includes an anode active material. The anode material 342 may also include a binder and an additive. The anode active material is any suitable anode active material that is compatible with a solid electrolyte. For example, the anode active material is formed of metal, preferably entirely of metal. The anode active material is preferably formed of lithium, sodium, magnesium, or a mixture thereof. For example, the anode active material may be formed of lithium or a lithium alloy. The anode material 342 has a thickness of approximately 20 μm to 40 μm.

The anode material 348 may also include an additive and/or a binder. The anode material 342 includes approximately 90-95 percent by weight of the anode active material and five to ten percent by weight of the additive plus the binder. For example, the anode material 342 may include approximately 95.0 percent by weight of the anode active material, 2.5 percent by weight of the additive and 2.5 percent by weight of the binder.

The binder may be any suitable electrode binder material. For example, the binder may include polyvinylidene fluoride, styrene-butadiene rubber, a cellulose material or any combination thereof. The additive may be any suitable sacrificial electrode additive, such as a material that acts as an additional source of lithium ions.

The anode material 342 may be formed by mixing the anode active material, the additive and the binder with a suitable solvent, such as N-methyl pyrrolidone (NMP). The weight ratio of the solvent to the sum of the anode active material, the additive and the binder may be approximately 2:1.

The anode material 342 is formed as a layer on the electrolyte material 332 so as to entirely cover the electrolyte material 332. For example, the anode material 342 is formed as a layer including a plurality of square-shaped raised portions 344 and a plurality of spaces 346 between the raised portions 344 such that the raised portions 344 and the spaces 346 form a grid-like pattern. The raised portions 344 are formed so as to mate with the second spaces 338 of the electrolyte material 332. However, it should be understood that the raised portions 344 may have any suitable shape as long as they are configured to mate with the second spaces 348 of the electrolyte material 332. The anode material 342 also includes a plurality of second spaces 348 under the raised portions 344. The shape of the second spaces 348 is based on the shape of the raised portions 344.

As shown in FIG. 5f, the second metal support 350 has a structure including a plurality of raised portions 352 and a plurality of spaces 354 between the raised portions 352. The second metal support 350 is formed of any suitable metal material, such as aluminum or copper, preferably copper. The second metal support 350 has a thickness ranging from 60 μm to 100 μm, preferably 60 μm. The second metal support 350 has a circular shape, but it should be understood that the second metal support 350 may have any suitable shape, such as a square or rectangular shape.

Together, the raised portions 352 and the spaces 354 form a plurality of grooves in the second metal support 350. The raised portions 352 are projections that protrude from an inner surface 358 of the second metal support 350. As shown in FIG. 5f, the plurality of grooves 356 is formed in a grid-like pattern. However, it should be understood that the grooves 356 may be formed in any suitable pattern, as long as the surface area of the second metal support 350 is increased as compared with the surface area of the second metal support 350 with no grooves. Preferably, the surface area of the second metal support 310 is increased at least 1.5 times, to approximately 140 mm² or more, by providing the grooves 356. The grooves 356 are preferably formed in a grid-like pattern, but a circular pattern, a pie-shaped pattern or a square pattern is also possible.

Each of the grooves 356 has a same prescribed depth d2 from a top surface of the second metal support 350 that faces the electrolyte 320 to the inner surface 358 of the second metal support 350. For example, each of the grooves 356 has a prescribed depth d2 of at least ⅓ of the total thickness of the second metal support 350. However, it should be understood that the grooves 356 may have different depths from the top surface of the second metal support 350 to the inner surface 358 of the second metal support 350, as long as each of the grooves 356 has a prescribed depth of at least ⅓ of the total thickness of the second metal support 350. Preferably, each of the grooves 356 has a prescribed depth of 20 μm to 40 μm.

The grooves 356 may be formed in any suitable manner, for example using a laser to perform laser etching. The grooves 356 may also be formed by stamping.

As shown in FIG. 5g, when the solid-state battery 300 is assembled, the battery 300 has a layered structure including the first metal support 310, the cathode 320, the electrolyte 330, the anode 340 and the second metal support 350. The cathode 320 is formed on the first metal support 310. The cathode 320 may be formed by depositing the cathode material 322 on the first metal support 310, for example by chemical or physical vapor deposition. The electrolyte 330 is formed on the cathode 320 by depositing the electrolyte material 332 on the cathode 320, for example via chemical or physical vapor deposition. The anode 340 is formed by depositing the anode material 342 on the electrolyte 330, for example by chemical or physical vapor deposition.

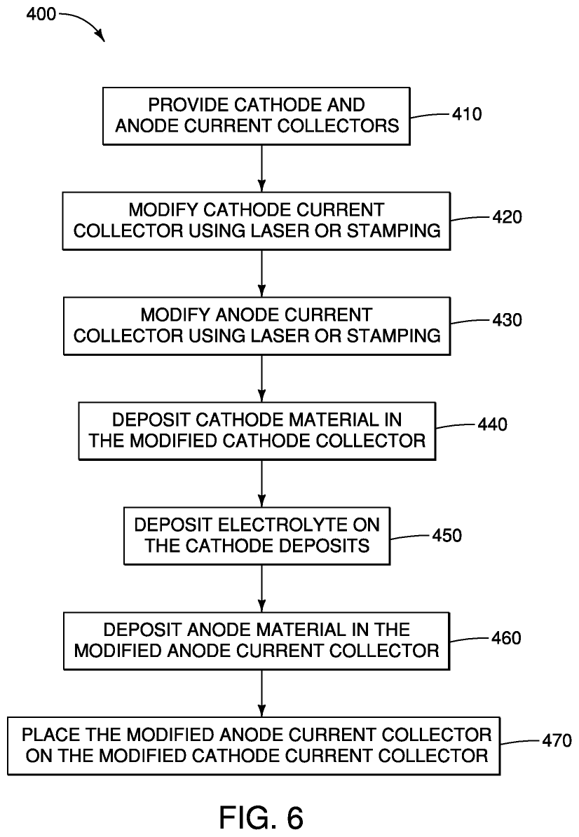

FIG. 6 illustrates a process 400 of producing a solid-state battery according to a sixth embodiment. In Step 410, a cathode current collector and an anode current collector are provided. The cathode and anode current collectors are formed of any suitable metal material, such as aluminum or copper. The cathode current collector is preferably formed of aluminum, and the anode current collector is preferably formed of copper. The cathode and anode current collectors each have a thickness ranging from 60 μm to 100 μm, preferably 60 μm. The cathode and anode current collectors in Step 410 also each have an initial surface area of, for example, approximately 80 mm². However, it should be understood that the thicknesses and initial surface areas of the cathode and anode current collectors may be different.

In Step 420, the cathode current collector is modified using a laser or stamping method to form a plurality of grooves in a pattern of concentric circles. However, it should be understood that the grooves may be formed in any suitable pattern, as long as the surface area of the cathode current collector is increased as compared with the initial surface area of the cathode current collector. Preferably, the surface area of the cathode current collector is increased at least 1.5 times to a surface area of approximately 140 mm² or more.

The cathode current collector is modified such that each of the grooves has a same prescribed depth from a first surface of the cathode current collector. For example, each of the grooves is formed to have a prescribed depth of at least ⅓ of the total thickness of the cathode current collector, for example, 20 μm to 40 μm. However, it should be understood that the grooves may have different depths from the first surface of the cathode current collector, as long as each of the grooves has a prescribed depth of at least ⅓ of the total thickness of the cathode current collector.

In Step 430, the anode current collector is modified using a laser or stamping method to form a plurality of grooves. It should be understood that the grooves may be formed in any suitable pattern, such as a pattern of concentric circles, as long as the surface area of the anode current collector is increased as compared with the initial surface area of the anode current collector. Preferably, the surface area of the anode current collector is increased at least 1.5 times to a surface area of approximately 140 mm² or more.

The anode current collector is modified such that each of the grooves has a same prescribed depth from a first surface of the anode current collector. For example, each of the grooves is formed to have a prescribed depth of at least ⅓ of the total thickness of the anode current collector, for example, 20 μm to 40 μm. However, it should be understood that the grooves may have different depths, as long as each of the grooves has a prescribed depth of at least ⅓ of the total thickness of the anode current collector.

In Step 440, a cathode material is deposited on the modified cathode current collector, for example, by chemical or physical vapor deposition, atomic layer deposition or electrophoretic deposition, so as to fill the grooves in the modified cathode current collector. The cathode material includes a cathode active material. The cathode active material is any suitable cathode active material that is compatible with a solid electrolyte. For example, the cathode active material may be a lithium transition metal oxide such as NMC or lithium cobalt oxide, lithium phosphate, lithium iron phosphate or a mixture thereof.

The cathode material may also include an additive (such as sacrificial cathode materials that acts as an additional source of lithium ions) and/or a binder. For example, the cathode material may have a same composition as the cathode material 7 of the first embodiment. For example, the cathode material includes at least 80 percent by weight of the cathode active material, preferably at least 90 percent by weight of the cathode active material. The cathode material also includes up to five percent by weight of the additive plus the binder. For example, the cathode material may include approximately two percent by weight of the additive and approximately three percent by weight of the binder relative to a total weight of the cathode material.

The binder may be any suitable electrode binder material. For example, the binder may include polyvinylidene fluoride, styrene-butadiene rubber, a cellulose material or any combination thereof. The additive may be any suitable sacrificial electrode additive, such as a material that acts as an additional source of lithium ions.

The cathode material preferably includes a mixture of NMC, an electron conducting material such as carbon and a lithium-ion conductive material such as a sulfide electrolyte.

In Step 450, an electrolyte material is deposited on the cathode material. The electrolyte material is a solid electrolyte and can be any suitable lithium-ion conductive solid electrolyte. For example, the solid electrolyte can be a sulfide solid electrolyte, an oxide solid electrolyte or a solid polymer electrolyte that includes a polymer having ion transport properties.

The electrolyte material is deposited on the cathode material, for example, by chemical or physical vapor deposition, atomic layer deposition or electrophoretic deposition, The electrolyte material is deposited on the cathode material in the modified cathode current collector so as to form a layer with a thickness of approximately 10 μm to 20 μm.

In Step 460, an anode material is deposited on the modified anode current collector, for example, by chemical or physical vapor deposition, atomic layer deposition or electrophoretic deposition, so as to fill the grooves in the modified anode current collector. The anode material includes an anode active material. The anode active material is any suitable anode active material that is compatible with a solid electrolyte. For example, the anode active material is formed of metal, preferably entirely of metal. The anode active material is preferably formed of lithium, sodium, magnesium, or a mixture thereof. For example, the anode active material may be formed of lithium or a lithium alloy.

The anode material may also include an additive and/or a binder. For example, the anode material has a same composition as the anode material 10 of the first embodiment. For example, the anode material includes approximately 90-95 percent by weight of the anode active material and five to ten percent by weight of the additive plus the binder. The anode material preferably includes 95.0 percent by weight of the anode active material, 2.5 percent by weight of the additive and 2.5 percent by weight of the binder.

The binder may be any suitable electrode binder material. For example, the binder may include polyvinylidene fluoride, styrene-butadiene rubber, a cellulose material or any combination thereof. The additive may be any suitable sacrificial electrode additive, such as a material that acts as an additional source of lithium ions.

The anode material may be formed by mixing the anode active material, the additive and the binder with a suitable solvent, such as N-methyl pyrrolidone (NMP). The weight ratio of the solvent to the sum of the anode active material, the additive and the binder may be approximately 2:1.

In Step 470, the modified anode current collector is placed on the modified cathode current collector to form the assembled solid-state battery. As with the solid-state battery of the first, second, third and fifth embodiments, the solid-state battery is preferably an all-solid-state battery and can be incorporated in a vehicle, a mobile device, a laptop computer or other suitable personal electronic devices.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including,” “having” and their derivatives. Also, the terms “part,” “section,” “portion,” or “element” when used in the singular can have the dual meaning of a single part or a plurality of parts.

The terms of degree, such as “approximately” or “substantially” as used herein, mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. An electrode comprising:
a current collector; and
an electrode material comprising an electrode active material,
the current collector comprising at least one groove formed in the current collector,
the electrode material being provided within the at least one groove, and
the at least one groove having a prescribed depth from a surface of the current collector.

2. The electrode according to claim 1, wherein
the current collector is formed of at least one of copper and aluminum.

3. The electrode according to claim 1, wherein
the prescribed depth ranges from 60 μm to 100 μm.

4. The electrode according to claim 1, wherein
the at least one groove comprises a plurality of grooves formed in a pattern in the current collector, each of the plurality of grooves having a same prescribed depth from the surface of the current collector.

5. The electrode according to claim 4, wherein
the pattern comprises at least one of: a plurality of concentric circles, and a plurality of pie-shaped pieces.

6. The electrode according to claim 1, wherein
the at least one groove is formed by at least one of: laser etching and stamping.

7. The electrode according to claim 1, wherein
the at least one groove is formed such that a surface area of the current collector is greater than a surface area of the current collector before the at least one groove is formed.

8. The electrode according to claim 1, wherein
the electrode material is provided on the surface of the current collector and within the at least one groove.

9. The electrode according to claim 1, wherein
the electrode active material is an anode active material that comprises at least one metal selected from the group consisting of: lithium, sodium and magnesium.

10. The electrode according to claim 1, wherein
the electrode active material is a cathode active material that comprises a lithium transition metal oxide.

11. A battery comprising
a cathode;
an anode; and
an electrolyte disposed between the cathode and the anode,
at least one of the anode and the cathode comprising:
a current collector; and
an electrode active material,
the current collector comprising at least one groove formed in the current collector,
the electrode material being provided within the at least one groove, and
the at least one groove having a prescribed depth from a surface of the current collector.

12. The battery according to claim 11, wherein
the prescribed depth ranges from 60 μm to 100 μm.

13. The battery according to claim 11, wherein
the at least one groove comprises a plurality of grooves formed in a pattern in the current collector, each of the plurality of grooves having a same prescribed depth from the surface of the current collector.

14. The battery according to claim 11, wherein
the at least one groove is formed by at least one of: laser etching and stamping.

15. The battery according to claim 11, wherein
each of the anode and the cathode comprises the at least one groove formed in the current collector,
the anode including an anode current collector and an anode material provided within the at least one groove of the anode current collector, and
the cathode including a cathode current collector and a cathode active material provided within the at least on groove of the cathode current collector.

16. The battery according to claim 15, wherein
the electrolyte includes at least one of: a solid polymer electrolyte, and a solid state electrolyte comprising sulfide.

17. A battery comprising:
a first metal support having at least one groove formed therein, the at least one groove having a prescribed depth from a first surface of the first metal support;
an anode material formed on the first metal support such that the anode material is provided on the first surface of the first metal support and within the at least one groove;
an electrolyte formed on the anode material such that the electrolyte is provided on the first surface of the first metal support and within the at least one groove;
a cathode material formed on the electrolyte such that the cathode material is provided on the first surface of the first metal support and within the at least one groove; and
a second metal support provided on the cathode material, the second metal support having at least one projection configured to mate with the at least one groove of the first metal support such that the at least one projection of the second metal support is provided within the at least one groove of the first metal support.

18. The battery according to claim 17, wherein
the prescribed depth ranges from 60 μm to 100 μm.

19. The battery according to claim 17, wherein
the at least one groove comprises a plurality of grooves formed in a pattern in the current collector, each of the plurality of grooves having a same prescribed depth from the surface of the current collector.

20. The battery according to claim 19, wherein
the at least one projection comprises a plurality of projections each configured to mate with one of the plurality of grooves such that each of the plurality of projections of the second metal support is provided within a respective one of the plurality of grooves of the first metal support.
